(19) United States
(12) Patent Application Publication
(10) Pub. No.: US 2002/0174445 A1
(43) Pub. Date: Nov. 21, 2002

(54) Video playback device with real-time on-line viewer feedback capability and method of operation

(75) Inventors: Andrew T. Miller, New York City, NY (US); John Zimmerman, Ossining, NY (US)

Correspondence Address: Michael E. Marion, Corporate Patent Counsel, U.S. Philips Corporation, 580 White Plains Road, Tarrytown, NY, 10591, US

(73) Assignee: Koninklijke Philips Electronics N.V.

(21) Appl. No.: 09/858,733

(22) Filed: May 17, 2001

(51) Int. Cl. H04N 7/173; H04N 1/00; H04N 7/16

(52) U.S. Cl. 725/134; 725/142; 386/124

(57) ABSTRACT

There is disclosed for use in a video playback device containing a disk storage device, an apparatus for retrieving from remote data servers in an external network supplemental data files related to a first television program stored on the disk storage device. The apparatus comprises: 1) a recording controller capable of recording on the disk storage device the first television program and link data associated with the first television program; and 2) an update controller capable of identifying the link data associated with the first television program, wherein the update controller is further capable of using the link data to access the supplemental data files on the remote data servers and to retrieve the supplemental data files.

### TECHNICAL FIELD OF THE INVENTION

The present invention is generally related to video playback devices and, more specifically, to a video playback device having an on-line capability for accessing viewer commentary and web site information related to a previously broadcast television program stored on said video playback device.

### BACKGROUND OF THE INVENTION

A wide variety of video playback devices are available in the marketplace. Most people own, or are familiar with, a video cassette recorder (VCR), also referred to as a video tape recorder (VTR). More recently, video recorders that use computer magnetic hard disks rather than magnetic cassette tapes to store video programs have appeared in the market. For example, the ReplayTV™ recorder and the TiVO™ recorder digitally record television programs on hard disk drives using, for example, MPEG-2 or MPEG-4 compression. Additionally, some video playback devices may record on a readable/writable digital versatile disk (DVD) rather than a magnetic disk.

The great advantage of a video playback device is that it permits a user to time-shift his or her television viewing habits. The user is free to watch a program hours, days or even weeks after it was originally recorded. Video playback devices also permit a user to view rented tapes.

Nonetheless, the capabilities of video playback devices are relatively limited, particularly in comparison to devices like personal computers. It is desirable to expand the capabilities of video playback devices. In particular, it is desirable to provide a video playback device with interactive, on-line capabilities that provide a more entertaining and interesting viewing experience for a user.

### SUMMARY OF THE INVENTION

To address the above-discussed deficiencies of the prior art, it is a primary object of the present invention to provide, for use in a video playback device containing a disk storage device, an apparatus for retrieving from remote data servers in an external network supplemental data files related to a first television program stored on the disk storage device. According to an advantageous embodiment of the present invention, the apparatus comprises: 1) a recording controller capable of recording on the disk storage device the first television program and link data associated with the first television program; and 2) an update controller capable of identifying the link data associated with the first television program, wherein the update controller is further capable of using the link data to access the supplemental data files on the remote data servers and to retrieve the supplemental data files.

According to one embodiment of the present invention, the update controller is capable of accessing and retrieving the supplemental data files while the first television program is being recorded.

According to another embodiment of the present invention, the update controller is capable of intermittently accessing and retrieving the supplemental data files after the first television program has been recorded on the disk storage device.

According to still another embodiment of the present invention, the update controller if further capable of displaying the supplemental data files on a display screen coupled to the video playback device.

According to yet another embodiment of the present invention, the link data comprises Universal Resource Locator (URL) links.

According to a further embodiment of the present invention, the supplemental data files comprise web page data identified by the URL links.

According to a still further embodiment of the present invention, the update controller comprises a processor capable of executing a browser application, wherein the update controller browses the external network in response to user commands received by the video playback device.

According to a yet further embodiment of the present invention, the browser application is stored on the disk storage device.

In one embodiment of the present invention, the link data comprises Electronic Program Guide (EPG) data associated with the first television program.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an exemplary video playback device and television set according to one embodiment of the present invention;

FIG. 2 illustrates in greater detail an exemplary video playback device according to one embodiment of the present invention;

FIG. 3 illustrates an exemplary television program according to one embodiment of the present invention;

FIG. 4 illustrates the contents of the exemplary hard disk drive according to one embodiment of the present invention; and

FIG. 5 is a flow diagram illustrating the operation of an exemplary video playback device according to one embodiment of the present invention.

### DETAILED DESCRIPTION OF THE INVENTION

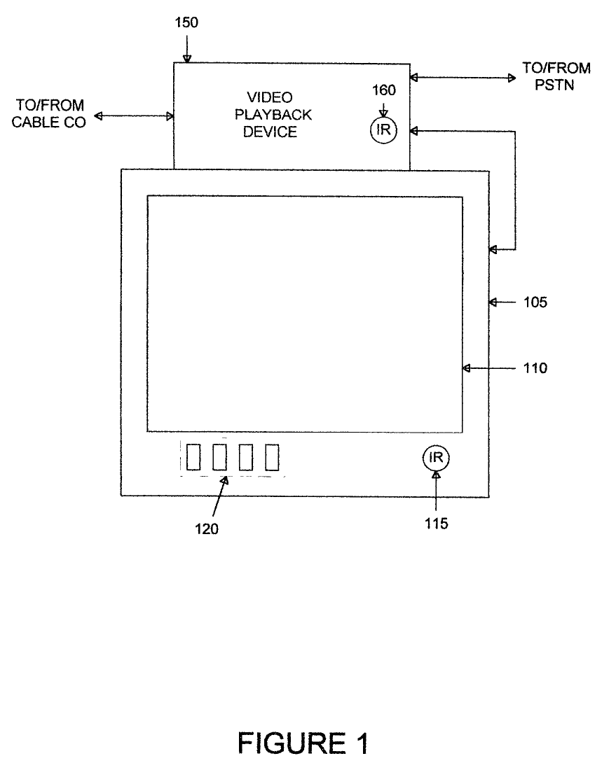

FIGS. 1 through 5, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged video playback device.

FIG. 1 illustrates exemplary video playback device 150 and television set 105 according to one embodiment of the present invention. Video playback device 150 receives television signals via an external source, such as a cable television service provider (Cable Co.), a satellite dish, or a local RF antenna, and transmits a viewer-selected channel to television set 105. In an advantageous embodiment of the present invention, video playback device 150 also transmits and receives Internet protocol (IP) packets via the cable television connection. In other embodiments, video playback device 150 may also have the capability to send and receive Internet protocol (IP) packets signals via a connection to the public switched telephone network. In RECORD mode, video playback device 150 may demodulate an incoming radio frequency (RF) television signal to produce a baseband video signal that is recorded and stored on a storage medium within or connected to video playback device 150. In PLAY mode, video playback device 150 reads a stored baseband video signal (i.e., program) selected by the user from the storage medium and transmits it to television set 105.

According to an exemplary embodiment of the present invention, video playback device 150 is a disk drive-based device, such as a ReplayTV recorder or a TiVO recorder. Video playback device 150 stores and retrieves the incoming television signals to and from a computer magnetic hard disk rather than a magnetic cassette tape. In other embodiments, video playback device 150 may store and retrieve from a local read/write (R/W) digital versatile disk (DVD) or R/W CD-ROM. Thus, the local storage medium may be fixed (i.e., hard disk drive) or removable (i.e., DVD, CD-ROM).

Video playback device 150 comprises infrared (IR) sensor 160 that receives commands (such as Channel Up, Channel Down, Volume Up, Volume Down, Record, Play, Fast Forward (FF), Reverse, and the like) from a remote control device operated by the user. As will be explained in greater detail below, IR sensor 160 may also receive user commands from a keyboard and/or mouse operated by the user that permits the user to view web page data and other types of data that video playback device 150 captures from broadcast, multicast and unicast transmissions. Television set 105 is a conventional television comprising screen 110, infrared (IR) sensor 115, and one or more manual controls 120 (indicated by a dotted line). IR sensor 115 also receives commands (such as volume up, volume down, power ON/OFF) from a remote control device operated by the viewer.

It should be noted that video playback device 150 is not limited to receiving a particular type of incoming television signal from a particular type of source. As noted above, the external source may be a cable TV connection, a conventional RF broadcast antenna, or a satellite dish. The incoming television signals may be a digital signal, an analog signal, or Internet protocol (IP) packets. However, for the purposes of simplicity and clarity in explaining the principles of the present invention, the descriptions that follow shall generally be directed to an embodiment in which video playback device 150 receives incoming television signals and IP traffic from a cable service provider.

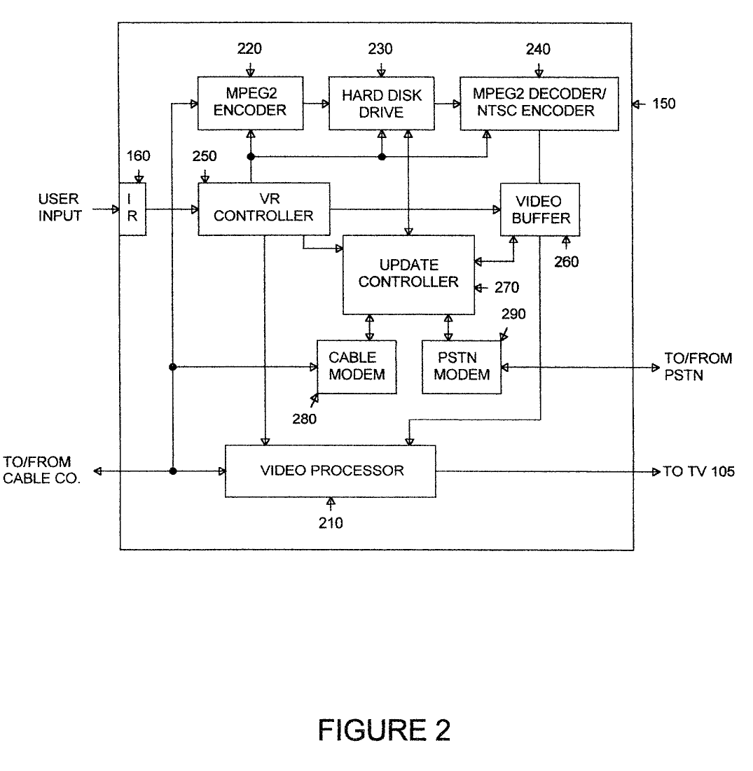

FIG. 2 illustrates exemplary video playback device 150 in greater detail according to one embodiment of the present invention. Video playback device 150 comprises IR sensor 160, video processor 210, MPEG2 encoder 220, hard disk drive 230, MPEG2 decoder/NTSC encoder 240, and video recorder (VR) controller 250. Video playback device 150 further comprises video buffer 260, update controller 270, cable modem 280 and PSTN modem 290. VR controller 250 directs the overall operation of video playback device 150, including View mode, Record mode, Play mode, Fast Forward (FF) mode, Reverse mode, Browser mode, and update mode, among others.

In VIEW mode, VR controller 250 causes the incoming television signal from the cable service provider to be demodulated and processed by video processor 210 and transmitted to television set 105, without storing or retrieving from hard disk drive 230. Video processor 210, which may be, for example, a TriMedia (TM) 1100 media processor, contains radio frequency (RF) front-end circuitry for receiving incoming television signals from the cable service provider, tuning to a user-selected channel, and converting the selected RF signal to a baseband television signal (e.g., super video or S-Video signal) suitable for display on television set 105. Video processor 210 also may receive a conventional NTSC signal from MPEG2 decoder/NTSC encoder 240 (after buffering in video buffer 260) during Play mode and transmitting a baseband television signal (e.g., S-Video signal) to television set 105.

In RECORD mode, VR controller 250 causes the incoming television signal to be stored on hard disk drive 230. Under the control of VR controller 250, MPEG2 encoder 220 receives the incoming television signal from the cable service provider and converts the received RF signal to MPEG format for storage on hard disk drive 230. In PLAY mode, VR controller 250 directs hard disk drive 230 to stream the stored television signal (i.e., program) to MPEG2 decoder/NTSC encoder 240, which converts the MPEG2 data retrieved from hard disk drive 230 to, for example, an S-Video signal that is buffered in video buffer 260 before video processor 210 transmits it to television set 205.

It should be noted that the choice of the MPEG2 standard for MPEG2 encoder 220 and MPEG2 decoder/NTSC encoder 240 is by way of illustration only. In alternate embodiments of the present invention, the MPEG encoder and decoder may comply with one or more of the MPEG-1, MPEG-2, MPEG-4, and MPEG-7 standards.

For the purposes of this application and the claims that follow, hard disk drive 230 is defined to include any mass storage device that is both readable and writable, including conventional magnetic disk drives and optical disk drives for read/write digital versatile disks (DVD-RW), re-writable CD-ROMs, VCR tapes and the like. In fact, hard disk drive 230 need not be fixed in the conventional sense that is permanently embedded in video playback device 150. Rather, hard disk drive 230 includes any mass storage device that is dedicated to video playback device 150 for the purpose of storing recorded video programs or downloaded broadcast data, multicast data, or unicast data. Thus, hard disk drive 230 may include an attached peripheral drive or removable disk drives (whether embedded or attached), such as a jukebox device that holds read/write DVDs or re-writable CD-ROMs. Furthermore, in an advantageous embodiment of the present invention, hard disk drive 230 may include external mass storage devices that video playback device 150 may access and control via a network connection (e.g., Internet protocol (IP) connection), including, for example, a disk drive in the user's home personal computer (PC) or a disk drive on a server at the user's Internet service provider (ISP).

In accordance with the principles of the present invention, update controller 270 is capable of accessing browsing web sites and other data servers on an external communication network, such as the Internet, via cable modem 280 or public switched telephone network (PSTN) modem 290. When television programs are recorded in RECORD mode, Universal Resource Locator (URL) links and other linking data that are embedded in the television signal are stored on hard disk drive 230, along with the conventional video and audio track data. During or after the recording of a television (TV) program, update controller 270 may periodically (or in response to user commands) access the web sites or data servers identified by the embedded URL links and download information regarding the recorded program. The downloaded information may include web pages, bulletin board pages, and viewer e-mails commenting on the TV program after the first broadcast of the TV program. In this manner, when the user finally watches a recorded TV program long after it has been broadcast for the first time, the user can browse the related web sites and read reviews of the TV program.

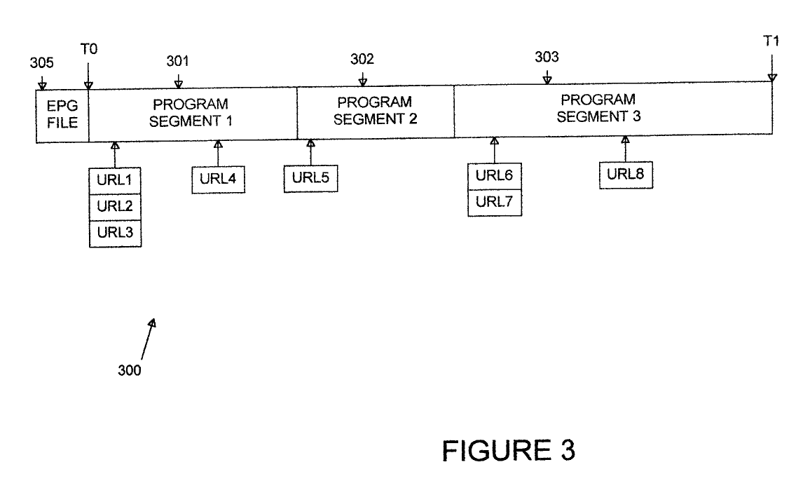

FIG. 3 illustrates exemplary television program 300 according to one embodiment of the present invention. Exemplary television program 300 begins at time T0 and ends at time T1. In FIG. 2, television program 300 comprises program segments 301-303, which are arbitrarily labeled Program Segment 1, Program Segment 2, and Program Segment 3. Program segments 301-303 contain the video track and audio track associated with television program 300. Television program 300 is preceded by electronic program guide (EPG) file 305, which contains supplemental information about television program 300 and other programs. The information in EPG file 305 may include channel listings, start and stop times, program summaries, and the like. EPG file 305 may be broadcast in a different channel than television program 300. Many cable television systems use a known, dedicated channel to broadcast EPG information. EPG file 305 is not required to immediately precede television program 300—it may have been broadcast minutes or even hours before television program 300.

Television program 300 also has associated therewith a plurality of links identifying data servers that store supplemental data files related to television program 200. In the exemplary embodiment, eight Universal Resource Locator (URL) identifiers are associated with television program 300. The use of URL links is by way of example only. Other types of links capable of identifying the network address of related data may also be used. Exemplary links URL1, URL2, URL3, and URL4 are associated with program segment 301. Exemplary link URL5 is associated with program segment 302. Exemplary links URL6, URL7 and URL8 are associated with program segment 303. By way of example, if television program 300 is a news program, URL1, URL2, and URL 3, which are located near the start of television program 300 may be links for web pages associated with the news program and the network that produces the news program. URL4 may be a link related to one of the first news items reported in the news program (e.g., a financial markets link). Similarly, URL8, which appears at the end of the news program when sports reports are usually given, may be a link to the web site of a local sports team in the city in which the news program is broadcast.

The eight exemplary links, URL1-URL8, may be accessed by the browser function of update controller 270. There are a number of well-known techniques for embedding linking information, such as URL1-URL8, in a television program. One of the most important of these techniques is part of the MPEG-7 standard. Under the MPEG-7 standard, it is possible to insert descriptor tables at different points in an MPEG video data stream to identify properties of the corresponding scene. These properties may include the names of actors or objects in the scene, the name of the director, the title of the television program, among other things. For the purposes of explaining the operation of the present invention, it shall be assumed hereafter that linking data, such as URL links, are embedded in television program 300 by means of MPEG-7 type descriptors tables, or the equivalent.

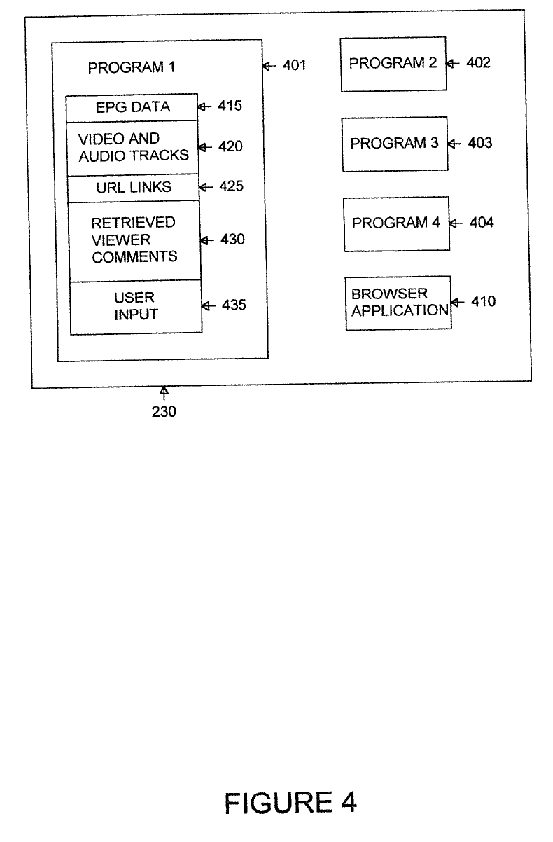

FIG. 4 illustrates the contents of hard disk drive 230 according to one embodiment of the present invention. Hard disk drive 230 stores exemplary recorded programs 401-404, which are arbitrarily labeled Program 1, Program 2, Program 3, and Program 4, respectively. In an advantageous embodiment of the present invention, hard disk drive 230 also stores browser application 410, which is executed by update controller 270 during Browse mode. When television program 300 is recorded, it is stored in recorded program 401, which comprises a group of sub-files, including EPG data file 415, video and audio tracks file 420, URL links file 425, retrieved viewer comments file 430, and user input file 435. Recorded programs 402-404 are similar to recorded program 401 and need not be explained in greater detail.

Selected portions of the electronic program guide (EPG) information received in EPG file 305 that are related to television program 300 are stored in EPG data file 415. The video and audio track data from television program 300 are stored in video and audio tracks file 420. The embedded links, URL1-URL8, for television program 300 are stored in URL links file 425. Viewer comments and other data retrieved from web sites or other data servers associated with UR11-URL8 are stored in retrieved viewer comments file 430. Finally, if the user enters a review of television program 300 using a keyboard and mouse, the user's comments are transmitted to the corresponding web site and a copy of the user's comments are stored in user input file 435.

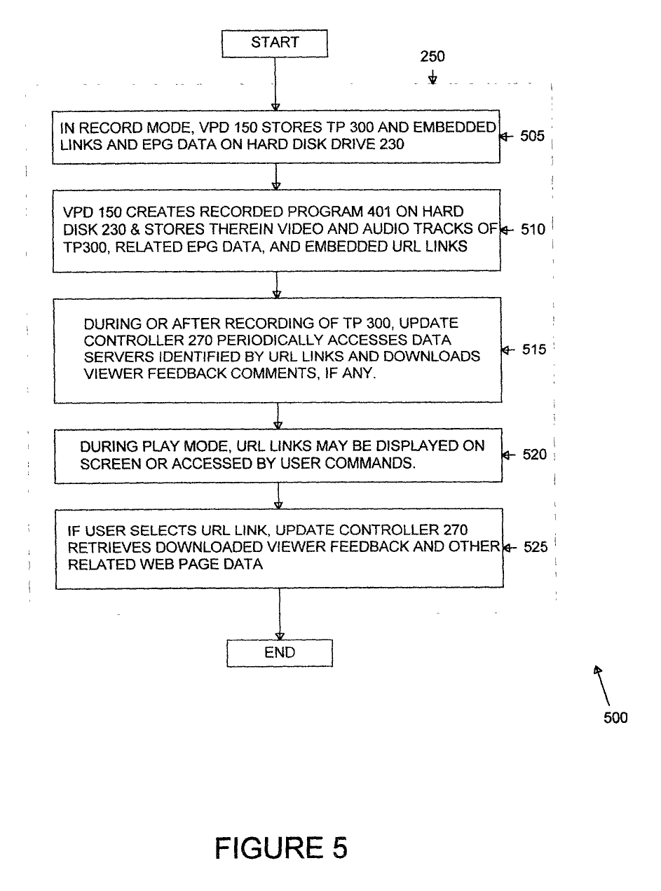

FIG. 5 depicts flow diagram 500, which illustrate the operation of exemplary video playback device 500 according to one embodiment of the present invention. In RECORD mode, video playback device 150 stores television program 300 and embedded links and EPG data on hard disk drive 230 (process step 505). Video playback device 150 creates recorded program 401 on hard disk 230 and stores therein video and audio tracks of television program 300, related EPG data, and embedded URL links (process step 510). During or after the recording of television program 300, update controller 270 periodically accesses data servers identified by the embedded URL links and downloads viewer feedback comments, if any (process step 515). During PLAY mode, the URL links (or small icons therefore) may be displayed on screen 110 (e.g., near the bottom) or may accessed by simple user commands (process step 520). If the user selects a URL link, update controller 270 retrieves downloaded viewer feedback and other related web page data (process step 525). The web page data is then displayed on screen 110 while the playback of television program 300 is paused. The user may then browse on the Internet via update controller 270 or may exit back to viewing television program 300.

Although the present invention has been described in detail, those skilled in the art should understand that they can make various changes, substitutions and alterations herein without departing from the spirit and scope of the invention in its broadest form.

What is claimed is:

1. For use in a video playback device containing a disk storage device, an apparatus for retrieving from remote data servers in an external network supplemental data files related to a first television program stored on said disk storage device, said apparatus comprising:
a recording controller capable of recording on said disk storage device said first television program and link data associated with said first television program; and
an update controller capable of identifying said link data associated with said first television program, wherein said update controller is further capable of using said link data to access said supplemental data files on said remote data servers and to retrieve said supplemental data files.

2. The apparatus as set forth in claim 1 wherein said update controller is capable of accessing and retrieving said supplemental data files while said first television program is being recorded.

3. The apparatus as set forth in claim 1 wherein said update controller is capable of intermittently accessing and retrieving said supplemental data files after said first television program has been recorded on said disk storage device.

4. The apparatus as set forth in claim 1 wherein said update controller if further capable of displaying said supplemental data files on a display screen coupled to said video playback device.

5. The apparatus as set forth in claim 4 wherein said link data comprises Universal Resource Locator (URL) links.

6. The apparatus as set forth in claim 5 wherein said supplemental data files comprise web page data identified by said URL links.

7. The apparatus as set forth in claim 4 wherein said update controller comprises a processor capable of executing a browser application, wherein said update controller browses said external network in response to user commands received by said video playback device.

8. The apparatus as set forth in claim 7 wherein said browser application is stored on said disk storage device.

9. The apparatus as set forth in claim 1 wherein said link data comprises Electronic Program Guide (EPG) data associated with said first television program.

10. A video playback device comprising:;
a disk storage device;
a recording controller capable of recording on said disk storage device a first television program and link data associated with said first television program; and
an apparatus for retrieving from remote data servers in an external network supplemental data files related to said first television program stored on said disk storage device, said apparatus comprising an update controller capable of identifying said link data associated with said first television program, wherein said update controller is further capable of using said link data to access said supplemental data files on said remote data servers and to retrieve said supplemental data files.

11. The video playback device as set forth in claim 10 wherein said update controller is capable of accessing and retrieving said supplemental data files while said first television program is being recorded.

12. The video playback device as set forth in claim 10 wherein said update controller is capable of intermittently accessing and retrieving said supplemental data files after said first television program has been recorded on said disk storage device.

13. The video playback device as set forth in claim 10 wherein said update controller if further capable of displaying said supplemental data files on a display screen coupled to said video playback device.

14. The video playback device as set forth in claim 13 wherein said link data comprises Universal Resource Locator (URL) links.

15. The video playback device as set forth in claim 14 wherein said supplemental data files comprise web page data identified by said URL links.

16. The video playback device as set forth in claim 15 wherein said update controller comprises a processor capable of executing a browser application, wherein said update controller browses said external network in response to user commands received by said video playback device.

17. The video playback device as set forth in claim 16 wherein said browser application is stored on said disk storage device.

18. The video playback device as set forth in claim 10 wherein said link data comprises Electronic Program Guide (EPG) data associated with said first television program.

19. For use in a video playback device containing a disk storage device, a method for retrieving from remote data servers in an external network supplemental data files related to a first television program stored on the disk storage device, the method comprising the steps of:
recording on the disk storage device the first television program and link data associated with the first television program; and
identifying the link data associated with the first television program;
accessing the supplemental data files on the remote data servers using the link data;
retrieving the supplemental data files; and
storing the supplemental data files on the disk storage device.

20. The method as set forth in claim 19 wherein the steps of accessing and retrieving are performed while the step of recording is being performed.

21. The method as set forth in claim 19 wherein the steps of accessing and retrieving are performed after the step of recording has been performed.
